(19) United States
(12) Patent Application Publication
(10) Pub. No.: US 2024/0368844 A1
(43) Pub. Date: Nov. 7, 2024

(54) FIBRE MOULDING PLANT FOR PRODUCING MOULDED PARTS FROM ENVIRONMENTALLY DEGRADABLE FIBRE MATERIAL

(71) Applicant: Kiefel GmbH, Freilassing (DE)

(72) Inventors: Richard Hagenauer, Saaldorf-Surheim (DE); Gerhard Wieser, Piding (DE); Matthias Hausmann, Unken (DE)

(21) Appl. No.: 17/754,792

(22) PCT Filed: Oct. 1, 2020
(86) PCT No.: PCT/DE2020/000229

§ 371 Date: Jul. 29, 2024

(30) Foreign Application Priority Data
Oct. 14, 2019 (DE) 102019127559.8

(51) Int. Cl. D21J 5/00; B23Q 3/155

(52) U.S. Cl. CPC D21J 5/00; B23Q 3/15503

(57) ABSTRACT

The invention relates to a fiber-forming system (100) comprising at least a molding station (20) according to the invention, a preforming station (30) according to the invention and a hot-pressing station (40) according to the invention for producing a formed part (10) from environmentally-friendly-degradable fiber material (11) by means of a fiber-forming process executed in the fiber-forming system (100), wherein the fiber-forming system (100) is designed to enable an automatic change of tools (2, 3, 400, 40u) from the molding station (20), preforming station (30) and or hot-pressing station (40). The invention also relates to such a molding station (20), preforming station (30) and hot-pressing station (40) and a corresponding method (200) for automatically changing tools in the fiber-forming system (100).

### FIELD OF THE INVENTION

The invention relates to a fiber-forming system comprising a molding station, a preforming station according to the invention and a hot-pressing station for producing a formed part from environmentally-friendly, degradable fiber material by means of a fiber-forming process performed in the fiber-forming system, the fiber-forming system enabling an automatic tool change from the molding station, preforming station and/or hot-pressing station. The invention also relates to such a molding station, preforming station and hot-pressing station, as well as a corresponding method for automatically changing tools in the fiber-forming system.

### BACKGROUND OF THE INVENTION

It is desirable to protect citizens and the environment from plastic pollution. In particular, single-use plastic products such as packaging materials or plastic cutlery and tableware generate a large amount of waste. In this respect, there is an increasing need for substitutes for packaging materials and containers made of plastic, with which these products can be made from recyclable plastics, materials with less plastic content or even from plastic-free materials.

The idea of using natural fibers instead of conventional plastics in the extrusion process has existed at least since the early 1990s, see for example EP 0 447 792 B1. As in most fiber-processing processes, the raw material basis here is pulp. In principle, pulp consists of water, natural fibers and a binder such as industrial starch (potato starch) and has a pulpy consistency.

Since consumers are interested in a wide variety of nature-friendly products with different sizes, shapes and requirements and do not necessarily want them in very large quantities, it would be desirable to have an effective and flexible manufacturing process for environmentally-friendly formed parts made of natural fibers and a corresponding machine to be able to produce products (formed parts) variably and with good quality in a reproducible manner.

### SUMMARY OF THE INVENTION

The object of the invention is to provide an effective and flexible production process for environmentally-friendly formed parts made of natural fibers and a corresponding machine with which different products (formed parts) can be produced in a variable and reproducible manner with good quality.

According to a first aspect of the invention, the object is achieved by a molding station for a fiber-forming system for molding a formed part made from environmentally-friendly-degradable fiber material in a fiber-forming process comprising
a suction tool comprising a plurality of suction heads, each with a three-dimensionally shaped suction head suction side for sucking in the environmentally-friendly-degradable fiber material by means of vacuum as suction pressure from a reservoir with a pulp as a liquid solution containing the environmentally-friendly-degradable fiber material for molding the formed part; and
a movement unit for at least partially immersing the suction tool in the pulp, on which movement unit the suction tool is reversibly mounted via a first interface suitable for automatic changing of the suction tool.

The term “environmentally-friendly-degradable fiber material” refers to fiber materials that can be decomposed by environmental factors such as moisture, temperature and/or light, with the decomposition process taking place in the short term, for example in the range of days, weeks or a few months. For the sake of simplicity, the “environmentally-friendly-degradable fiber material” is sometimes referred to below as simply “fiber material”. Preferably, neither the fiber material nor the decomposition products should pose an environmental hazard or contamination. Fiber materials, which in the context of the present invention represent an environmentally-friendly-degradable fiber material, are, for example, natural fibers obtained from cellulose, paper, cardboard, wood, grass, plant fibers, sugar cane residues, hemp, etc. or from their components or parts thereof and/or correspondingly recycled material. However, an environmentally-friendly-degradable fiber material can also refer to artificially produced fibers such as PLA (polylactide), etc., which correspond to the above fiber materials or have their properties. The environmentally-friendly-degradable fiber material is preferably compostable. The environmentally-friendly-degradable fiber material and the containers made from it are preferably suitable for introduction into the material cycle of the German organic compost bin and as a resource for biogas plants. The fiber materials and the containers made from them are preferably biodegradable in accordance with EU standard EN 13432.

The term “pulp” refers to fluid masses that contain fibers, here an environmentally-friendly-degradable fiber material. The term “liquid” refers here to the state of aggregation of the pulp, the liquid pulp comprising the environmentally-friendly-degradable fiber material in the form of fibers (liquid solution with the environmentally-friendly-degradable fiber material). The fibers may be present as individual fibers, as a fiber structure or as a fiber group composed of a number of connected fibers. The fibers represent the fiber material, regardless of whether they are in the pulp as individual fibers, as a fiber structure or as a group of fibers. The fibers are dissolved in the liquid solution in such a way that they float in the liquid solution as much as possible with the same concentration, regardless of location, for example as a mixture or suspension of liquid solution and fiber material. For this purpose, the pulp can be appropriately tempered and/or circulated, for example, in some embodiments. The pulp preferably has a low consistency, i.e., a proportion of fiber material of less than 8%. In one embodiment, a pulp with a proportion of environmentally-friendly, degradable fiber material of less than 5%, preferably less than 2%, particularly preferably between 0.5% and 1.0%, is used in the method according to the invention. This small proportion of fiber material can, among other things, prevent clumping of the fiber material in the liquid solution, so that the fiber material can still be molded onto the suction tool with good quality. Clumped fiber material can be sucked in by the suction tool, but would probably result in a formed part with a fluctuating layer thickness, which should be avoided in the production of the formed parts if possible. In this respect, the proportion of fiber material in the pulp should be small enough so that clumping or chaining does not occur or occurs only to a negligible extent. The liquid solution can be any solution suitable for the fiber-forming process. For example, the pulp can be an aqueous solution containing environmentally-friendly, degradable fiber material. An aqueous solution is, among other things, an easy-to-handle solution. The pulp may contain no organic binder, preferably also no non-organic binder. Without a binder, the formed parts produced from originally environmentally-friendly-degradable fiber material can be degraded in a particularly environmentally-friendly manner, since no environmentally-critical binder, preferably no binder at all, is used. The elimination of binders is made possible by the combination of molding, preforming and hot-pressing steps, which as a whole ensure good mechanical interlinking of the individual fibers with one another in the fiber material of the formed part. The mechanical linkage is so strong that binders for ensuring the dimensional stability of the formed part can be dispensed with. In one embodiment, the environmentally-friendly-degradable fiber material essentially consists of fibers with a fiber length of less than 5 mm. With fibers of this length, one obtains, among other things, a good, homogeneous solution of the fiber material in the liquid solution, so that the degree of clumping of the fibers in the pulp is sufficiently low for a good, reproducible fiber-forming process for the formed part. In one embodiment, the pulp is provided at a temperature of less than or equal to 80° C., preferably less than or equal to 50° C., particularly preferably at room temperature. These low temperatures allow, among other things, a simple process control, especially at room temperature. At higher temperatures, hot-pressing process can be slightly accelerated.

The fiber-forming process refers to the process steps involved in forming the formed part, beginning with providing the pulp, the molding of the formed part from the fiber material from the pulp in the molding station, the preforming of the formed part in the preforming station, the hot-pressing of the formed part in the hot-pressing station and optionally the coating of the formed part with functional coatings, wherein the coating can be arranged at any point in the fiber-forming process that is suitable for the respective coating to be applied.

The formed parts can have any shape, also referred to here as a contour, provided this shape (or contour) can be produced in the method according to the invention or the method is suitable for producing this shape (or contour). The components used for the fiber-forming process can be adapted to the respective shape (or contour) of the formed part. In the case of different formed parts with different shapes (or contours), different correspondingly adapted components such as the suction tool, the suction head, the prepressing unit, the hot-pressing station, etc. can be used. The target contour of the formed part and thus the corresponding forming components is preferably designed in such a way that all surfaces of the formed part have an angle a of at least 3 degrees to the pressing direction during hot-pressing. For example, a surface perpendicular to the pressing direction (maximum pressure) has an angle α=90 degrees. This ensures that the hot-pressing pressure can be applied to all surfaces of the formed part. No pressure can be applied to surfaces parallel to the direction of pressure during hot-pressing. Formed parts in their final shape can represent a wide variety of products, for example cups, containers, vessels, lids, bowls, portioned containers, casings or containers for a wide variety of purposes.

The suction tool refers here to the tool in which the suction heads for molding the formed part are arranged so that when the suction tool is moved, the individual suction heads in the suction tool are also moved. The supply of media to the suction tool with a plurality of suction heads is routed in a suitable manner to the individual suction heads in the suction tool. Such a suction tool is referred to as a multi-tool because it comprises a plurality of suction heads. With a multi-tool, a plurality of formed parts can be formed simultaneously from a common pulp bath according to the number of suction heads, which increases the throughput of the fiber-forming system and thus allows the fiber-forming system to produce more economically.

The at least partial immersion of the suction tool in the pulp means that all of the suction heads in the suction tool at least come into contact with the pulp in such a way that, due to the vacuum or suction pressure applied to the pulp with the suction tool, the fiber material is sucked out of the pulp or the pulp with fiber material dissolved therein is sucked in. During the partial immersion into the pulp, the suction tool is not only placed on the pulp, but immersed into it. The immersion depth of the suction tool in the pulp depends on the respective application and the respective fiber-forming process and can differ depending on the application and possibly the formed part to be formed.

The suction head can have a negative form. A negative form is a form where the suction side of the suction head, i.e., the side where the fiber material is deposited due to the suction effect of the suction head and thus molds the formed part, is on the inside of the suction head, so that this inside, after the suction head has been placed on the pulp or the suction head has been immersed in the pulp, forms a cavity into which the pulp with the fiber material is sucked (as shown in FIG. 1). In the case of a negative form, the outside of the subsequent formed part faces the inside of the suction head. After molding, the formed part therefore sits on the inside of the suction head.

The suction head can also have a positive form. A positive form is a form where the suction side of the suction head, i.e., the side where the fiber material is deposited due to the suction effect of the suction head and thus forms the formed part, is on the outside of the suction head, so that this outside, after the suction head has been placed on the pulp or the suction head has been immersed in the pulp, does not form a cavity (as shown in FIG. 1). In the case of a positive form, the inside of the subsequent formed part faces the outside of the suction head. After molding, the formed part therefore sits on the outside of the suction head.

The molding of the formed part refers to a first preforming of the formed part, whereby said formed part is formed from fiber material formerly randomly distributed in the pulp by means of accumulation of the fiber material on the contour of the suction head with the corresponding contour. The formed part still has a large proportion, for example 70%-80%, of liquid solution, for example water, and is therefore not yet dimensionally stable.

By means of the molding station, a formed part is easily formed from a pulp with a fiber material, which can very flexibly deliver formed parts with a wide variety of contours, depending on the design of the contour of the suction head. The ratio of width or diameter to height of the formed part does not represent a limiting or critical parameter for the quality of the production of the respective formed part. The molding station according to the invention makes it possible to produce the formed parts in a very reproducible manner and with great accuracy and quality with regard to the shape and layer thickness of the individual formed part sections. The molding station is able to process fibers of all kinds, as long as they can be dissolved in such a way that larger clumping of the fibers in the liquid solution can be avoided before processing.

By using a first interface for attaching the suction tool to the movement unit for the suction tool, standardized suction tools can be used, which enable the suction tool to be exchanged quickly and automatically, if required.

The interface (first, second, third, fourth, fifth or further interface) is the transition from the respective tool (suction tool, modules of the suction tool, prepressing unit, hot-pressing upper unit, hot-pressing lower unit) to the component or station holding the tool. Interface refers to both the shape of the tool at the transition and the shape of the holding component or station at this transition. The shape relates here, for example, to the geometric shape of the transitions on both sides to one another, the fastening means on one side of the interface, i.e., on the tool side and on the holding component or station side, as well as their interaction to produce a fixed mechanical connection for holding the tool on the corresponding component or station, as well as the connections for the media supply on the tool side and on the holding component or station side, as well as their interaction to produce an error-free media supply passing through the interface, for example, in the form of respective pipes with push-in couplings located at the respective transitions on both sides of the interface, so that a corresponding media connection is made through the interface by means of push-in couplings pushed into each other.

The molding station according to the invention thus enables an effective and flexible manufacturing process for environmentally-friendly formed parts made of natural fibers and a corresponding machine with which different products (formed parts) can be produced in a variable and reproducible manner with good quality.

In one embodiment, the first interface is formed by media connections that are mutually compatible, preferably vacuum and/or overpressure connections, and mechanical fastening devices that are mutually compatible on the movement unit side and the suction tool side. The mutually compatible media connections and/or the compatible mechanical fastening devices may be designed as reversible quick-release fasteners, preferably a bayonet fastener and/or push-in connectors that snap into one another. Mutually compatible refers to connections on both sides that can be interlocked by means of contact, so that the connections can carry out their functions correctly. Due to mutually compatible means, the tools can be changed quickly and easily. For all interfaces described in the present invention (first, second, third, fourth, fifth, or further interface), the term “media connection” refers to corresponding means for the transfer or passing of a medium through the interface. For example, a media connection can be a pipeline or an electrical cable connection. Media such as gas, liquids or electricity can be passed through these media connections. Conventionally available systems can be used as quick-release systems. Alternatively, magnetic clamping systems, hydraulic clamping units, lever clamping devices or a mechanical claw coupling can also be used. These quick-release systems have inserts for centering, suitable power transmission elements and locking units for locking reliability.

In one embodiment, the movement unit comprises a robotic arm that can move freely in space, and on which the suction tool is mounted via the first interface. As a result, the molding station can easily and flexibly supply one or more preforming stations and/or one or more hot-pressing stations with molded or preformed parts. The manufacturing process can be accelerated or modified depending on the required production rate, among other things. In a further embodiment, the movement unit is therefore provided to transfer the formed parts in the suction tool to the prepressing unit of a preforming station and/or to the hot-pressing station.

In a further embodiment, the robotic arm can be controlled in such a way that it moves to a tool changing station for a tool change in order to deposit the suction tool in a designated changing position and that it mechanically, electrically or hydraulically detaches the fastening devices and media connections from one another in such a way that the suction tool is no longer connected to the robotic arm. The tool changing position may be designed, for example, as a table with several changing positions provided on it. After the robotic arm is free of the suction tool, it can subsequently pick up another suction tool, for example from the tool changing station, by performing the previous steps in reverse order.

In a further embodiment, the suction tool comprises a base plate with suction heads mounted thereon and a gas line system in the base plate which distributes at least the vacuum provided via the first interface to the suction heads as the suction pressure for sucking in the fiber material. The gas line system provides, for example, a vacuum to generate the suction pressure at the suction heads or overpressure to eject the formed or preformed formed parts from the suction tool at the respective suction heads. The base plate can be connected to the movement unit in a simple and standardized way, while the suction heads mounted on it can differ depending on the desired formed part. The base plate enables the suction heads to be exchanged quickly, if necessary. The vacuum for the suction pressure can be distributed to the suction heads, for example, by a vacuum pump positioned at a location remote from the suction tool via the gas line system.

In a further embodiment, the base plate forms a second interface with media connections that are compatible with the individual suction heads and compatible mechanical fastening devices, so that individual or all suction heads can be reversibly connected to the base plate. This makes it possible to quickly and variably equip the base plate with suction heads in a standardized manner when changing tools or preparing tools.

In a further embodiment, the gas line system in the base plate branches out laterally from at least one media connection of the first interface to all suction head positions and is routed in the suction direction above the suction heads vertically relative to the base plate to the suction heads, which further facilitates the above tool change or tool preparation. In a further embodiment, the suction heads are also fastened to the base plate by means of snap-in or clampable push-in connectors. Push-in connectors enable the suction heads to be changed very quickly.

In a further embodiment, the shapes of the suction heads in the suction tool can differ at least in part, with the same shapes of the suction heads being arranged adjacent to each other in the suction tool in separate modules, optionally in modules of different sizes, with the push-in connectors of these modules being compatible with those in the base plate. Such a suction tool is able to produce different formed parts simultaneously in the same fiber-forming process. For example, vessels such as cups and the associated lids can be simultaneously formed and further processed in the same suction tool.

In a further embodiment, the suction head suction side of the suction head is formed from a porous screen which is fastened in the suction head only with reversible fastening means, preferably clamping means, preferably the screen can be fastened in at least some of the suction channels. The screen must have a porosity so that the pulp together with the fiber material can be sucked through the screen and the liquid solution of the pulp can pass through the screen. However, the porosity of the screen must not be too large so that the fiber material can adhere to the pulp side. Due to the reversible mounting of the screen, the screens can be quickly and easily removed from the suction tool for cleaning processes or exchanged, if necessary. This exchange is also favored, among other things, by the fact that the screen is already supported by it resting on the suction-side surface, which avoids additional brackets.

The object is achieved according to a second aspect of the invention by a preforming station for a fiber-forming system for preforming a formed part from environmentally-friendly-degradable fiber material in a fiber-forming process, comprising a prepressing unit for exerting a prepressing pressure on the formed part molded by means of a molding station according to one of the preceding claims in order to reduce a proportion of the liquid solution in the formed part and for dimensional stabilization of the formed part, the prepressing unit being designed as a multi-tool with a plurality of prepressing lower tools adapted to the suction tool, the prepressing unit being mounted reversibly with the preforming station via a third interface suitable for automatic changing of the prepressing unit. The term “third interface” here also refers to the transition from the respective tool (here the prepressing unit) to the component or station holding the tool (here the preforming station), to which what has already been described above for interfaces equally applies.

The formed part remaining in the suction tool is placed on the prepressing lower tool for prepressing in such a way that it is arranged between the prepressing lower tool and the suction tool, so that the suction tool can be pressed onto the prepressing lower tool with the prepressing pressure. In one embodiment, the prepressing lower tool has a pressing surface facing the formed part that has a lower surface roughness than the screen. The suction tool can be pressed onto a stationary prepressing lower tool or the prepressing lower tool is pressed onto a stationary suction tool. The term “place” only refers to the relative movement of the suction tool to the prepressing lower tool. When prepressing, the suction tool represents the prepressing upper tool of the prepressing unit. In one embodiment, the suction tool is placed on the prepressing lower tool and pressed onto the prepressing lower tool by means of a separate pressing unit, preferably a piston rod. Alternatively, the suction tool can also be attached to a robotic arm, which itself exerts the prepressing pressure on the prepressing lower tool via the suction tool. By means of the preforming station, a preformed part that is sufficiently stable for further processing and has a further reduced proportion of liquid solution is produced in a simple manner from a mechanically still unstable formed part by means of prepressing. Here, too, the ratio of the width or diameter to the height of the formed part does not represent a limiting or critical parameter for the quality of the production of the respective formed parts. The preforming station according to the invention makes it possible to produce and further process the formed parts in a very reproducible manner and with great accuracy and quality with regard to the shape and layer thickness of the individual formed part sections. In one embodiment, the prepressing can be performed at a temperature of the prepressing unit of less than 80° C., preferably less than 50° C., particularly preferably at room temperature. The prepressing reduces the liquid content in the formed part to approx. 55%-65% and the formed part is pre-solidified in such a way that it is sufficiently dimensionally stable for tool transfer. Too high a temperature would lower the liquid content in the formed part too much, which would make the material too stiff for the subsequent hot-pressing. It is exactly the combination of prepressing and hot-pressing that in particular enables the reproducible production of good-quality formed parts with a low level of rejects. In a further embodiment, the prepressing is performed at the prepressing pressure between 0.2 N/mm² and 0.3 N/mm², preferably between 0.23 N/mm² and 0.27 N/mm². These moderate pressures, which are lower than the hot-pressing pressure, enable gentle solidification of the formed part with a moderate reduction in liquid, which is advantageous for a low-waste hot-pressing process. In particular, stable formed parts can be produced easily, effectively and flexibly from environmentally-friendly-degradable fiber material with good quality and good reproducibility.

By using a third interface for attaching the prepressing unit to the preforming station, standardized prepressing units can be used, which enable the respective prepressing unit to be exchanged quickly and automatically, if required.

The preforming station according to the invention thus enables an effective and flexible manufacturing process for environmentally-friendly formed parts made from natural fibers and a corresponding machine with which different products (formed parts) can be produced in a variable and reproducible manner with good quality.

In one embodiment, the third interface is formed by mutually compatible mechanical fastening devices on the prepressing unit side and on the preforming station side, preferably additionally by mutually compatible media connections, particularly preferably the media connections comprise heating and/or compressed gas connections. Mutually compatible refers to connections on both sides that can be interlocked by means of contact, so that the connections can carry out their functions correctly. Due to mutually compatible means, the tools can be changed quickly and easily. The fasteners are provided with each prepressing unit for attachment to the preforming station. Media connections, on the other hand, are only required if the prepressing unit is to be heated to a prepressing temperature (lower than the hot-pressing temperature) and/or if the prepressing unit is essentially made of an elastomer material and compressed air is to be applied during the prepressing.

The mutually compatible mechanical fastening devices can be a reversible quick-clamping system, preferably a bayonet connection and/or push-in connectors that snap into one another. The same also applies if mutually compatible media connections are present at the third interface.

In a further embodiment, the third interface on the prepressing unit side comprises a carrier plate on which the lower prepressing tools are arranged. Thanks to the carrier plate, the interface on the prepressing unit side can be easily standardized and the carrier plate can also be manufactured to be mechanically robust for upcoming tool changes. The interface on the preforming station side can be easily adapted to the dimensions and designs of the carrier plate, so that the tool change can be performed reliably.

In a further embodiment, the carrier plate comprises a transport interface for automatically changing the prepressing unit using a movement unit. In this case, the movement unit that changes the tool is preferably the movement unit of the molding station, which otherwise carries the suction tool. The transport interface can be arranged on the side of the carrier plate outside of the arrangement of the lower prepressing tools. For this tool change, the media connections of the movement unit do not have to be compatible with the prepressing unit, nor connected to those of the prepressing unit, since the transport interface of the prepressing unit is arranged separately from the third interface on the carrier plate.

In a further embodiment, the transport interface is arranged in such a way that the prepressing unit can be removed from the movement unit of the molding station via the first interface on the movement unit side during a tool change from the preforming station or inserted into it. Since the suction tool and the prepressing unit have to be adapted to one another in order to carry out the prepressing, a change of the suction tool also requires a change of the prepressing unit. For example, the suction tool could be placed in a changing position, then the movement unit released by the suction tool (e.g. the released robotic arm) also removes the prepressing unit from the preforming station and also places it on the changing station. The new prepressing unit, which was also on the changing table when the tool was changed, is then inserted into the preforming station. The movement unit then picks up the new suction tool, which was also on the changing table, for further production. In this embodiment, the transport interface may be designed to be compatible with the first interface with regard to the fastening devices, so that the movement unit can carry both the suction tool and the prepressing unit for a tool change. For this tool change, the media connections of the movement unit do not have to be compatible with the prepressing unit, nor connected to those of the prepressing unit, since the transport interface of the prepressing unit is arranged separately from the third interface on the carrier plate.

In a further embodiment, the carrier plate additionally comprises a heating element, preferably a heating element extending over the surface of the carrier plate, for heating the lower prepressing tools. This modular structure facilitates the handling of the components and their interchangeability.

In a further embodiment, the prepressing lower tool is made at least in part from an elastomer, preferably silicone, and has a cavity which is surrounded by a wall made of the elastomer as a pressing surface, the prepressing unit being designed to apply gas pressure on the cavity during prepressing to generate the prepressing pressure or at least to facilitate it. Prepressing lower tools made of an elastomer or at least partially made of elastomer are advantageous because the elastomer can still be easily deformed under pressure and can therefore be flexibly adapted as a multi-tool to a suction tool that may bend under the prepressing pressure, thus increasing the homogeneity of the improved forming of the various formed parts in the multi-suction tool. For increased prepressing temperatures below 100° C., for example, silicone as an elastomer is also well suited as a material that is temperature-resistant in this range. When gas pressure is applied, the prepressing lower tools are “inflated” on the back and fit particularly well to the contour of the formed part, so that the quality of the preforming process is improved, especially for the reproducible production of identical formed parts.

In one embodiment, the preforming station further comprises a pulp preparation and replenishment unit for replenishing the pulp to the reservoir. In this way, the pulp can be fed to the reservoir with controlled quality and constant concentration as it is consumed by the molding. The liquid solution discharged during molding can thus be returned to the reservoir after processing, for example adding fiber material to set the desired concentration of fiber material in the pulp, and can thus be reused in the fiber-forming process. In a further embodiment, the pulp preparation and replenishment unit therefore refills the reservoir at least periodically, preferably continuously, as a function of the consumption of pulp by the molding of the formed part, in order to ensure that the reservoir is filled to the required level for molding.

The object is achieved according to a third aspect of the invention by a hot-pressing station for a fiber-forming system for final shaping of a formed part from environmentally-friendly-degradable fiber material in a fiber-forming process comprising a hot-pressing lower unit as a multi-tool with a plurality of hot-pressing lower tools, each adapted to a contour of the formed part for receiving the respective hot-pressing lower tools, and a hot-pressing upper unit as a multi-tool with a plurality of hot-pressing upper tools adapted to the formed part for placing on or inserting into the formed part along a closing direction for the hot-pressing station, the hot-pressing lower unit and/or the hot-pressing upper unit being provided for exerting a hot-pressing pressure on the formed parts arranged between the respective hot-pressing lower tools and hot-pressing upper tools during hot-pressing, the hot-pressing upper unit and the hot-pressing lower unit having the hot-pressing station reversibly mounted via respective fourth interfaces, suitable for automatic changing of the hot-pressing upper unit and/or the hot-pressing lower unit. The term “fourth interface” also refers to the transition from the respective tool (here the hot-pressing upper units and hot-pressing lower units) to the component or station holding the tool (here the hot-pressing station), to which what has been described above for interfaces also applies.

After prepressing has taken place, the preformed formed part is preferably transferred to the hot-pressing station by means of the suction tool, with the formed part being removed from the suction tool for the subsequent hot-pressing. The transfer is advantageous in that the hot-pressing is performed at a high temperature with a significantly higher pressure. If the formed part were to remain in the suction tool without being transferred for hot-pressing, the fiber material could get caught in the screen of the suction tool and, after hot-pressing, be removed from the suction tool only with difficulty, possibly only with damage. In addition, the screen could be damaged by the high pressure, so that the suction tool would then no longer be functional. The transfer can take place in such a way that the formed part or parts are transferred from the suction tool to the hot-pressing station either passively by depositing them or actively by means of an ejection pressure in the suction tool against the formed parts. With the hot-pressing of the prepressed formed part with a hot-pressing pressure, the formed part is final-shaped with a further reduction in the proportion of the liquid solution in the formed part, for example to below 10%, preferably to approximately 7%, after which it is then stable and dimensionally stable. Preferably, the hot-pressing lower and upper tools are made of metal. The hot-pressing is performed at the hot-pressing pressure that is higher than the prepressing pressure, for example at a hot-pressing pressure between 0.5 N/mm² and 1.5 N/mm², preferably between 0.8 N/mm² and 1.2 N/mm². The hot-pressing pressure can be applied for a pressing time of less than 20 s, preferably more than 8 s, particularly preferably between 10 and 14 s, even more preferably 12 s. The hot-pressing pressure is applied hydraulically to the hot-pressing station, for example via a piston rod, wherein this piston rod presses, for example, on the hot-pressing upper tool, which in turn presses on the stationary hot-pressing lower tool, with the formed part in between. The arrangement could also be reversed. The hot-pressing station is a simple way of producing a preformed and still slightly variable formed part by means of hot-pressing a final-shaped formed part with a significantly reduced proportion of liquid solution for further processing. Here, too, the ratio of the width or diameter to the height of the formed part does not represent a limiting or critical parameter for the quality of the production of the respective formed parts. The hot-pressing station according to the invention makes it possible to produce and further process the formed parts in a very reproducible manner and with great accuracy and quality with regard to the shape and layer thickness of the individual formed part sections. In particular, it is possible in this way to produce end-stable formed parts in a simple, effective and flexible manner from environmentally-friendly-degradable fiber material with good quality and good reproducibility.

By using a fourth interface for attaching the hot-pressing upper unit and the hot-pressing lower unit, respectively, to the hot-pressing station, standardized hot-pressing upper units and hot-pressing lower units can be used, which enables quick and automatic exchange of the respective hot-pressing upper units and hot-pressing lower units, if required. Either a hot-pressing upper unit or a hot-pressing lower unit alone can be changed, for example for maintenance purposes. If production is to be switched to a different formed part, both upper and lower hot-pressing units must be changed, as their shapes are adapted to one another for the hot-pressing process so that the formed part can be hot-pressed between the two units.

The preforming station according to the invention thus enables an effective and flexible manufacturing process for environmentally-friendly formed parts made from natural fibers and a corresponding machine with which different products (formed parts) can be produced in a variable and reproducible manner with good quality.

In one embodiment, the fourth interface is formed by a mutually compatible mechanical fastening device and mutually compatible media connections on the hot-pressing upper unit side and/or hot-pressing lower unit side and on a corresponding holding device side of the hot-pressing station. Mutually compatible refers to connections on both sides that can be interlocked by means of contact, so that the connections can perform their functions correctly. Due to mutually compatible means, the tools can be changed quickly and easily. In addition to heating connections (e.g. electrical heating connections such as compatible plugs), the media connections may also include compressed gas and vacuum connections. These gas connections can be used, for example, to hold formed parts in the respective hot-pressing upper tools, depending on the process step, by means of a vacuum and/or to release the final-shaped formed parts from the hot-pressing upper tools by means of overpressure. The holding devices in the hot-pressing station can be designed as holding plates.

In a further embodiment, the compatible mechanical fastening device and/or the mutually compatible media connections are designed as a reversible quick-action clamping system, preferably a bayonet connection and/or plush-in connections which snap into one another.

In a further embodiment, the holding devices comprise at least two defined tool zero points on their sides facing the respective hot-pressing upper and lower units for positioning the hot-pressing upper unit and/or hot-pressing lower unit on the respective holding devices. The tool zero points can be in the form of mechanical stops with corresponding counter forms in the hot-pressing upper and lower units, so that the position of the hot-pressing upper and lower units is defined in relation to the holding device. The tool zero points can be designed to be self-centering, which makes it easier to assemble the hot-pressing upper and lower units on the holding device and avoids assembly errors, and it may comprise a temperature compensation so that temperature fluctuations do not affect the position of the hot-pressing upper and lower units relative to the holding device and thus also do not affect the positions of the hot-pressing upper and lower units to one another in the hot-pressing station. For temperature compensation, the position of the tool zero points is selected such that the tool expands equally in all directions from this position. This means that regardless of the temperature, all the coordinates of the upper and lower tools are always in the same place, despite thermal expansion.

In a further embodiment, the holding device of the hot-pressing station for the hot-pressing upper unit comprises a fall protection device against detachment of the hot-pressing upper unit from the holding plate. Accidentally falling hot-pressing upper tools can damage the machine components below and possibly endanger people, which is avoided by the fall protection, among other things.

In a further embodiment, the holding device comprises an additional transport interface for automatically changing the hot-pressing upper unit and/or the hot-pressing lower unit by means of a movement unit. The transport interface can be arranged laterally on the hot-pressing upper and lower units outside of the arrangement of the hot-pressing lower and upper tools. For this tool change, the media connections of the movement unit do not have to be compatible with the hot-pressing upper and lower units, nor connected to those of the hot-pressing upper and lower units, since the transport interface of the hot-pressing upper and lower units is arranged separately from the fourth interface. For example, the transport interface can be arranged perpendicularly to the closing direction for the hot-pressing station in order, among other things, to be more easily accessible for a tool change. In a further embodiment, the transport interface comprises the compressed gas and vacuum connections (media connections).

In a further embodiment, the transport interface is arranged such that hot-pressing upper and lower units can be removed from or inserted into the hot-pressing station by the movement unit on the molding station side via the first interface during a tool change. As a result, in the case of the movement unit being the same as the movement unit of the molding station, the tool change for the entire fiber-forming system can be performed analogously to the tool change described above for the molding and preforming stations, also for the hot-pressing station with a correspondingly designed changing station that has been expanded accordingly for the hot-pressing upper and lower units to be exchanged.

In a further embodiment, the holding device comprises, separately from the transport interface, a heating current interface for transferring a heating current to the hot-pressing upper unit and/or hot-pressing lower unit. The separate heating current interface allows, among other things, the required heating currents, particularly in the case of large heating currents, to be supplied to the hot-pressing lower and upper units more simply and possibly more reliably. The hot-pressing sides of the hot-pressing lower tool and the hot-pressing upper tool facing the formed part can be heated, for example, by means of electric heating cartridges.

In a further embodiment, the fourth interface on the hot-pressing upper unit side and the hot-pressing lower unit side each comprises a carrier plate on which the hot-pressing lower tools or hot-pressing upper tools are arranged. The interface on the hot-pressing upper side and lower unit side can be easily standardized thanks to the carrier plate for the hot-pressing upper and lower units. In addition, the carrier plate can also be manufactured to be mechanically robust for the upcoming tool changes. The interface on the hot-pressing station side can be easily adapted to the dimensions and designs of the carrier plate, so that the tool change can be performed reliably.

In a further embodiment, the respective carrier plates comprise a thermal insulation layer in order to thermally insulate the respective carrier plates from the holding device. Among other things, this allows the process temperature to be kept as constant as possible in order to keep the necessary heating output for the hot-pressing upper and lower units as low as possible.

In a further embodiment, one or more expansion means are arranged in the carrier plate between the thermal insulation layer and a side of the carrier plate facing the holding device, in order to improve the positional accuracy of the carrier plate in relation to the holding device. In this way, temperature fluctuations when opening and closing the hot-pressing station can be compensated for in relation to the holders and other components.

In a further embodiment, the carrier plate of the hot-pressing upper unit comprises a gas line system in order to apply a vacuum in the respective hot-pressing upper tools, depending on the process step, to hold the formed parts in and/or an overpressure to eject the final-shaped formed parts from the hot-pressing upper tools. Integration of the gas line system into the carrier plate facilitates the provision of standardized connections at the respective interfaces.

In a further embodiment, the gas line system in the carrier plate branches laterally from at least one media connection of the fourth interface to all positions of the hot-pressing lower tools and hot-pressing upper tools, respectively, and is routed to the hot-pressing lower tools and hot-pressing upper tools, respectively, in the closing direction of the hot-pressing station vertically in respect to the carrier plate, which further facilitates the above tool change or tool preparation.

In a further embodiment, the hot-pressing upper unit and the hot-pressing lower unit are each mounted in the hot-pressing station so that they can be moved laterally in order to enable a tool change of the respective hot-pressing lower unit and hot-pressing upper unit outside of a process area of the hot-pressing station. This means that changes can be performed quickly and easily.

In a further embodiment, one or more heating cartridges are arranged in both the hot-pressing lower unit and the hot-pressing upper unit in such a way that the hot-pressing lower tools and hot-pressing upper tools are heated to temperatures greater than 150° C., preferably between 180° C. and 250° C. Electric heating cartridges allow for rapid heating of the hot-pressing lower tool and hot-pressing upper tool when the tools are closed, after the tools have cooled by opening the hot-pressing station to remove the final-shaped formed parts. This means that the liquid (or moisture) in the formed part can be reduced quickly and reliably to below 10%.

The invention also relates to a fiber-forming system comprising at least one molding station according to the invention, a preforming station according to the invention and a hot-pressing station according to the invention for producing formed parts from environmentally-friendly-degradable fiber material by means of a fiber-forming process performed in the fiber-forming system, the fiber-forming system being designed to enable an automatic change of tools from the molding station, preforming station and/or hot-pressing station. The fiber-forming system according to the invention thus enables an effective and flexible manufacturing process for environmentally-friendly formed parts made from natural fibers and a corresponding machine with which different products (formed parts) can be produced variably and with good quality in a reproducible manner.

In one embodiment, the fiber-forming system comprises at least one tool changing station, in which at least one tool of the group of tools comprising the suction tool, the prepressing unit, the hot-pressing upper unit and/or the hot-pressing lower unit can be positioned for an automatic tool change for the respective other tool in the fiber-forming system. The changing station can be designed as a changing table with appropriate positions for the tools to be exchanged or as a shelf with appropriate storage positions. The tool changing station should comprise at least sufficient space for depositing the tool to be exchanged and for picking up the subsequent tool. The tool changing station preferably comprises sufficient space for all tools to be exchanged and picked-up in the fiber-forming system. The tools and the tool positions provided for them are preferably clearly identified by means of an identification code on the respective tool. The tool positions assigned to the tool can also be encoded or are stored in a table in the controller of the movement unit for execution. For this purpose, the tool changing station comprises suitable identification mark readers, for example barcode readers or RFID readers.

In a further embodiment, the tool changing station comprises a plurality of tool changing positions which are adapted to the shape of the respective tool. The assignment of the tool to a corresponding station (molding, preforming or hot-pressing station) is clearly evident from the position of the tool.

In a further embodiment, the tool changing station comprises a conveyor belt for the tools to be changed, which is designed to transport the tools to be changed to the respective tool changing positions or to transport the changed tool out of the tool changing positions. The tools that have been changed or are to be changed can be removed from the danger zone or supplied to the danger zone of the movement unit by the conveyor belt, so that the tools can be prepared outside the danger zone for a tool change or for maintenance.

In a further embodiment, the tool changing station comprises a movement unit, preferably a robot with a gripper arm, to place the tools provided with the conveyor belt in the desired tool changing positions, which further increases the degree of automation of the tool change by accelerating the transporting of the tools to and from the changing positions.

In a further alternative embodiment, the tool changing station comprises a movement unit designed as a robot for the tools to be changed, which is designed to transport the tools to be changed to the respective tool changing positions or to transport the changed tool out of the tool changing positions again. As a result, a conveyor belt can be avoided.

In a further embodiment, the movement unit of the forming station, the preforming station, the hot-pressing station and the tool changing station are positioned relative to one another in such a way that the movement unit of the molding station, in its function as a changing unit, can automatically deposit and remove the tools of these stations in the tool changing station, wherein at least the respective transport interfaces of the preforming station and/or the hot-pressing station are configured in such a way that they are designed to be compatible with the first interface of the movement unit as a changing unit. In this way, the fiber-forming system can be built very compactly, suitable for an automatic tool change, and additional components for transporting the exchanged tools to and from it can be avoided or minimized.

In one embodiment, the fiber-forming system comprises a control unit for controlling at least the molding station, the preforming station and the hot-pressing station, as well as other components. The control unit can be implemented as a processor, separate computer system or web-based and is suitably connected to the components of the fiber-forming system to be controlled, for example via data cable or wirelessly by means of WLAN, radio or other wireless transmission means.

In a further embodiment, the fiber-forming system also comprises a coating unit for applying one or more functional coatings to the formed part. With such functional coatings, additional functionalities such as moisture, aroma, odor or taste barriers or barriers against fats, oils, gases such as O2 and N2, light acids and all substances that contribute to the perishability of food and/or non-food-grade substances are applied to the formed part. For this purpose, the coating unit can be arranged at any position in the process sequence for producing the formed part that is suitable for the coating to be applied. Depending on the application, the functional coating can be arranged during the suction process, after prepressing or after hot-pressing. The term “functional coating” refers here to any additional coating applied to the original fiber material, which is applied both to an inner side and/or to an outer side of the formed part over the whole area or in partial areas.

In a further embodiment, the fiber-forming system additionally comprises an output unit for outputting the formed part in its final shape. The output unit outputs the formed part for further transport or for further processing, for example to subsequent cutting, inscribing, printing, stacking and/or packing stations, for example with the aid of a conveyor belt.

The invention also relates to a method for automatically changing tools in a fiber-forming system according to the invention, comprising the following steps:
providing a tool to be exchanged in a changing station in a first changing position;
depositing the exchanged tool in the changing station in a second changing position;
removing the tool to be exchanged from the first changing position and inserting this tool, depending on the tool, in a molding station according to the invention, in a preforming station according to the invention or in a hot-pressing station according to the invention; and
removing the exchanged tool from the second changing position from the changing station.

The fiber-forming system according to the invention thus enables an

effective and flexible production process for environmentally-friendly formed parts made from natural fibers and a corresponding machine with which different products (formed parts) can be produced variably and with good quality in a reproducible manner.

It should be expressly pointed out that, for the purpose of better readability, “at least” expressions have been avoided as far as possible. Rather, an indefinite article (“one”, “two” etc.) is normally to be understood as “at least one, at least two, etc.”, unless it follows from the context that “exactly” the specified number is meant there.

At this point it should also be mentioned that within the scope of the present patent application, the expression “in particular” is always to be understood in the sense of an optional, preferred feature being introduced with this expression. The expression is therefore not to be understood as “specifically” and not as “namely”.

It goes without saying that features of the solutions described above or in the claims can also be combined, if appropriate, in order to be able to cumulatively implement the advantages and effects that can be achieved here.

### BRIEF DESCRIPTION OF THE FIGURES

In addition, further features, effects and advantages of the present invention are explained with reference to the attached drawing and the following description. Components which at least essentially correspond in terms of their function in the individual figures are identified by the same reference symbols, with the components not having to be numbered and explained in all figures.

In the figures:

FIG. 1: shows an embodiment of the suction head with a negative and positive form (a) before molding and (b) after molding the formed part;

FIG. 2: shows an embodiment of the suction head according to the invention as a lateral section;

FIG. 3: shows an embodiment of the suction tool for the molding station according to the invention as a lateral section as a multi-tool with a plurality of suction heads;

FIG. 4: shows a further embodiment of the suction tool according to the invention with modules (a) in plan view of the suction side and (b) in lateral section along the cutting plane A-B;

FIG. 5: shows an embodiment of the base plate in the suction tool of the molding station according to the invention in a perspective view;

FIG. 6: shows an embodiment of the preforming stations according to the invention together with the molding station according to the invention;

FIG. 7: shows an embodiment of the prepressing unit according to the invention as a multi-tool with a plurality of prepressing lower tools adapted to the suction tool (a) in a perspective view of the prepressing unit and (b) in a lateral section of a single prepressing lower tool of the prepressing unit;

FIG. 8: shows an embodiment of the hot-pressing station according to the invention (a) in side view and (b) in perspective view;

FIG. 9: shows an embodiment of a carrier plate for the hot-pressing upper unit as an interface between the hot-pressing station and the hot-pressing upper unit;

FIG. 10: shows a schematic representation of an embodiment of the hot-pressing lower tool and hot-pressing upper tool of the hot-pressing station from FIG. 8 during hot-pressing;

FIG. 11: shows an embodiment of the carrier plate in a hot-pressing upper or lower unit of the hot-pressing station according to the invention in a perspective view;

FIG. 12: shows an embodiment of the fiber-forming system according to the invention; and

FIG. 13: shows a schematic representation of an embodiment of the method according to the invention.

### EXEMPLARY EMBODIMENTS

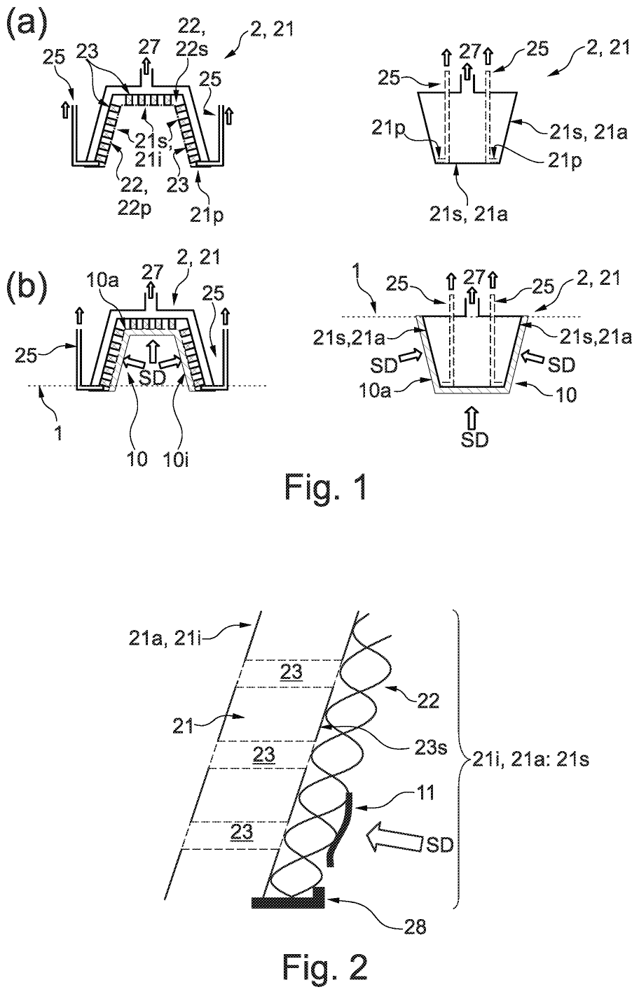

FIG. 1 shows an embodiment of the suction head 21 in a suction tool 2 with negative and positive form (a) before molding and (b) after molding of the formed part in a molding station 20 for a fiber-forming system 100 for molding 210 a formed part 10 made from environmentally-friendly-degradable fiber material 11. The molding station is described globally in FIG. 6, while only the suction tool 2 for sucking in, from a reservoir 6 with a pulp 1 as a liquid solution with the environmentally-friendly-degradable fiber material 11, the environmentally-friendly-degradable fiber material 11 for molding 210 the formed part 10 is discussed, wherein the suction tool 2 comprises a suction head 21 with a three-dimensionally shaped suction head suction side 21s, the shape of which is adapted to a contour 10i, 10a of the future formed part 10, and the formed part 10 is molded on the suction head suction side 21s by means of a vacuum in the suction tool 2. The suction head suction side 21s of the suction head 21 is formed from a porous screen 22, on whose pulp side 22p facing the pulp 1 the environmentally-friendly-degradable fiber 11 adheres due to the suction for molding 130 of the formed part 10 (see formed part 10 in FIG. 2c). For this purpose, the suction tool 2 comprises a plurality of suction channels 23 which terminate on the suction-side surface 23s below the screen 22 and are distributed over the suction-side surface 23s in such a way that essentially the same suction power is made possible in all areas between the screen 22 and the suction-side surface 23s. For this purpose, the suction channels 23 can have openings in the suction-side surface 23s with diameters of less than 4 mm. The cross-sectional area of the suction channels 23 can have any suitable shape, for example the cross-sectional area can be circular or oval. For this purpose, the suction channels 23 also have an uneven distribution on the suction-side surface 23s, wherein in the area of negative edges in the formed part 10 by 40%-60% fewer and/or in the area of positive edges 10%-30% more suction channels 23 per unit area arranged than with plane surfaces. The suction head for molding the formed part only needs to be slightly immersed in the pulp 1, so that a closed cavity is formed in the interior space 21i of the suction head. In other embodiments, the suction head 21 could also be completely immersed in the pulp 1. The liquid solution of the pulp 1 passing through the screen 22 during the molding 130 is discharged from the suction tool 2. For this purpose, the suction head 21 comprises on its end face 21p facing the pulp 1 a collecting ring 24 for receiving the liquid solution of the pulp 1 sucked through the suction head suction side 21s, which collecting ring is connected to a discharge channel 25 for the liquid solution. The suction head suction side 21s of the suction head 21 can be designed either as a negative form (left part of FIG. 1) as the suction head inside 21i or as a positive form (right part of FIG. 1) as the suction head outside 21a. In the case of a negative form, the formed part 10 (gray inner layer in the suction head 21, FIG. 1b left) which is formed toward the inside 21i of the suction head by means of the suction pressure SD is placed on the prepressing lower tool 31 with a pressing surface 31a as the outer surface of the prepressing lower tool 31 for prepressing. With a positive form, the suction head 21 is completely immersed in the pulp 1 for contacting 120 to suck up the pulp 1 with the fiber material 11. Thereafter, the formed part 10 (gray outer layer on the suction head 21, FIG. 1b right) which is formed on the outside of the suction head 21a due to the suction pressure SD is inserted for prepressing into the prepressing lower tool 31, which has a shape adapted to the positive form of the suction head 21 with a pressing surface 31 as an inner surface of the prepressing lower tool 31. The suction head 21 also comprises a gas line system 27, which supplies the vacuum provided to the suction head 21 as suction pressure SD. The pulp 1 can contain less than 5%, preferably less than 2%, particularly preferably between 0.5% and 1.0% of environmentally-friendly, degradable fiber material 11 in a liquid solution, for example an aqueous solution. Advantageously, the pulp 1 does not comprise any organic binder, preferably no binder at all. The environmentally-friendly-degradable fiber material 11 can essentially consist of fibers with a fiber length of less than 5 mm. The pulp 1 is provided at a temperature of less than or equal to 80° C., preferably less than or equal to 50° C., particularly preferably at room temperature.

FIG. 2 shows an embodiment of the suction head 21 according to the invention as a lateral section, with the screen 22 having a wavy structure along the suction-side surface 23s. The screen 22 rests on the suction-side surface 23s during suction and is thereby mechanically supported in its shape by the suction-side surface 23 so that the screen 22 does not change geometrically in the molding process and therefore ensures shape accuracy for the subsequently formed formed part. The screen 22 is fixed in the suction head 21 (indicated on the underside) with a reversible fixing means 28, designed here as clamping means, on the suction head 21. Additionally or alternatively, the screen 22 could also be attached in at least some of the suction channels 23. In addition, the fiber 11 is an example of the molded fiber material 11, indicating how the fiber material 11 is molded on the screen 22, so that the formed part is molded as a whole as a result of the pulp being sucked in.

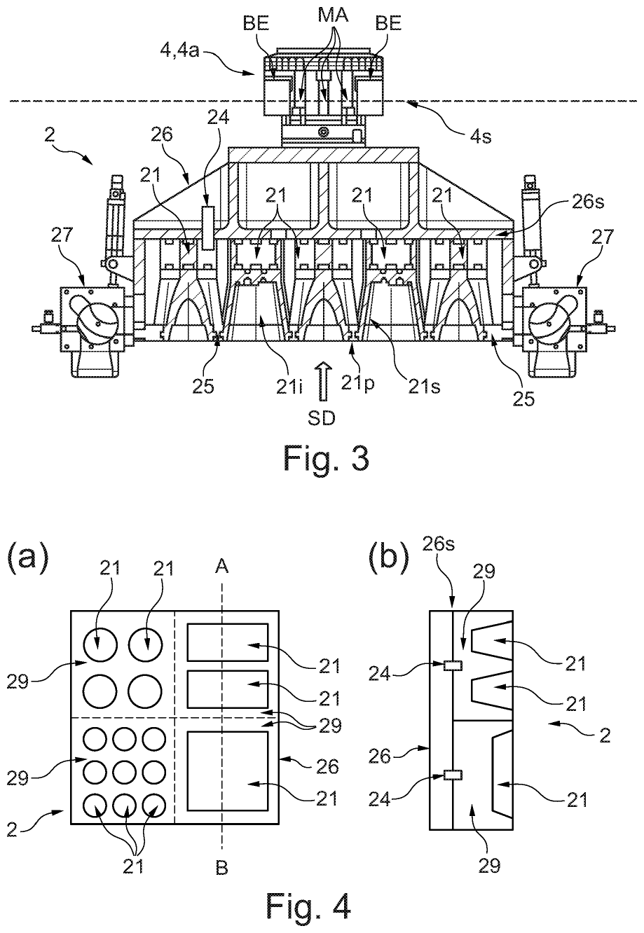

FIG. 3 shows an embodiment of the suction tool 2 for the molding station according to the invention in a side section as a multi-tool with a plurality of suction heads 21. The molding station comprises a suction tool 2 with a plurality of suction heads 21, as shown, for example, in FIGS. 1 and 2, and a movement unit 4 for at least partially immersing the suction tool 2 in the pulp 1, on which movement unit the suction tool 2 is reversibly mounted via a first interface 4s, which is suitable for an automatic tool change, of the suction tool 2. The suction heads 21 are arranged on the suction side 21s in a two-dimensional arrangement with four rows of five suction heads 21 each. In other embodiments, multi-tools 2 can also have different numbers of rows and columns of suction heads 21. The suction tool 2 here comprises a base plate 26 with suction heads 21 mounted thereon and a gas line system 27 in the base plate 26. The base plate 26 is not to be understood here exclusively as a thin plate, but refers to the rear structure of the suction tool 2, which serves to connect the movement unit 4 and the suction heads 21. The gas line system 27 distributes the vacuum provided by a vacuum pump (not shown here) as suction pressure SD to the suction heads 21 for sucking in the fiber material 11. The gas line system 27 comprises, for example, one or more compressed gas lines for applying compressed air to the suction heads 21 in order, for example, to release or eject the molded or preformed formed parts 11 from the suction heads 21. The gas line system 27 for the vacuum (suction pressure) for molding the formed parts 11 comprises one or more main gas lines and secondary gas lines, wherein the main gas lines are provided, for example, for generating a pre-vacuum and the secondary gas lines are provided, for example, as a supplement to the main gas lines to achieve the suction pressure SD after bringing the suction tool 21 in contact with the pulp 1. The main gas lines preferably have a large cross section, while the secondary gas lines have a smaller cross section. One or more valves are arranged in the gas line system 27 to switch off the suction pressure SD at the suction heads 21 as soon as the suction tool has left the pulp 1, and/or to switch on at least the secondary gas lines to the main lines as soon as the suction tool 2 is immersed and has entered the pulp 1. The suction tool 2 is connected to the robotic arm 4a via the interface 4s, which is formed by mutually compatible media connections MA, here vacuum and overpressure connections, and mutually compatible fastening devices on the movement unit 4 side and the suction tool 2 side. The mutually compatible media connections MA and/or the compatible mechanical fastening devices BE can be, for example, reversible quick-release fasteners, preferably a bayonet fastener and/or push-in connectors that snap into one another. The movement unit is designed here as a robotic arm 4a that can move freely in space, on which robotic arm the suction tool 2 is mounted via the first interface 4s. The robotic arm 4a can be controlled in such a way that it moves to a tool changing station 60 for a tool change to deposit the suction tool 2 in a designated changing position 61 and mechanically, electrically or hydraulically detach the fastening devices BE and media connections MA from one another in such a way that the suction tool 2 is no longer connected to the robotic arm 4a. The movement unit 4 and suction tool 2 are also designed to eject the formed parts 10 from the suction heads 21 of the suction tool 2 by means of compressed air provided by the compressed gas line 27d and distributed to the individual suction heads 21 via the base plate 26.

FIG. 4 shows a further embodiment of the suction tool 2 according to the invention with modules 29 (a) in a plan view of the suction side and (b) in a lateral section along the cutting plane A-B. The individual shapes of the suction heads 21 in the suction tool 2 as a multi-tool can differ at least in part, with the same shapes of the suction heads 21 being arranged adjacently in the suction tool 2 in separate modules 29, respectively. For example, in a first module 29, there are four suction heads for the production of larger cups, in a second module 29 six suction heads for the production of smaller cups, in a third module 29 two suction heads for the production of smaller bowls and in a fourth module 29 one suction head for making one larger bowl. In this case, the base plate 26 forms a second interface 26s with media connections that are compatible with the individual suction heads 21 and compatible mechanical fastening devices, so that individual or all suction heads 21 can be reversibly connected to the base plate 26. The suction heads 21 or the modules 29 are fastened to the base plate 26 by means of snap-in or clampable push-in connectors 24. The push-in connectors 24 of these modules 29 are compatible with those in the base plate 26.

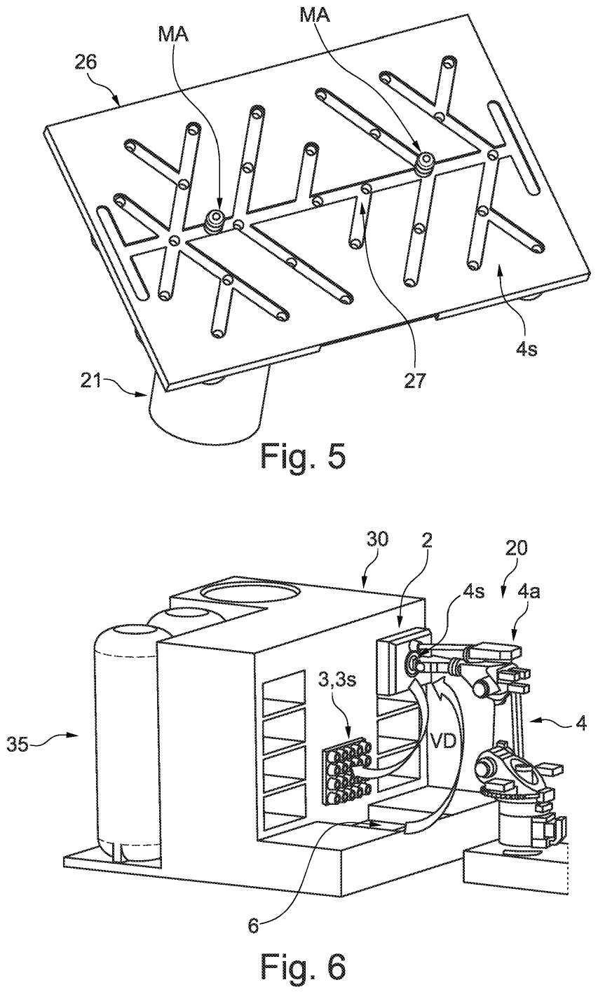

FIG. 5 shows an embodiment of the base plate 26 in the suction tool 2 of the molding station 20 according to the invention in a perspective view, wherein the gas line system 27 in the base plate 26 branches out laterally from two media connections MA of the first interface 4s to all suction head positions and is routed in the suction direction above the suction heads 21 vertically relative to the base plate 26 to the suction heads 21. As an example of the plurality of suction heads 21 on the base plate 26, an exemplary suction head 21 on the base plate 26 is shown here.

FIG. 6 shows an embodiment of the preforming stations 30 according to the invention together with the molding station 20 according to the invention. The molding station 20 comprises the suction tool 2 as a multi-tool for sucking in the environmentally-friendly-degradable fiber material 11 for molding the formed part 10 from a reservoir 6 with a pulp 1 as a liquid solution with the environmentally-friendly-degradable fiber material 11 (further details on the suction head see FIGS. 1-5) and a movement unit 4 on which the suction tool 2 is mounted and which is intended at least for placing the suction tool 2 on or for partially immersing it on or in the pulp 1. The preforming station 30 comprises a prepressing unit 3 for applying a prepressing pressure VD to the formed part 10 molded by means of the molding station 20 to reduce a proportion of the liquid solution in the formed part 10 and to stabilize the shape of the formed part 10. Corresponding to the suction tool 2, the prepressing unit 3 is also designed as a multi-tool with a plurality of prepressing lower tools 31 adapted to the suction tool 2, with the prepressing unit 3 being mounted reversibly with the preforming station 30 via a third interface 3s in order to automatically change the prepressing unit 3 as needed. The preforming station 30 also comprises a reservoir 6 of pulp 1 for molding the formed part 10 in the suction tool 2. The reservoir 6 is arranged as a horizontal reservoir 6 that is open at the top, so that the suction tool 2 can easily be immersed into the pulp 1 by the movement unit 4. Furthermore, the preforming station 30 comprises a pulp preparation and replenishment unit 35 for replenishing the pulp 1 of the reservoir 6. In the pulp preparation and replenishing unit 35, the pulp is, for example, premixed from a solvent and a fiber material 11, finally mixed to form the production pulp 1, fed into the reservoir and/or reused from returns from the suction tool 2 and/or the prepressing unit 3, wherein the proportion of the fiber material 11 has to be reset to the desired proportion so that in the course of the process the pulp 1 does not become too thin in regard to the fiber material 11. The prepressing unit 3 is here arranged in a vertical orientation above the reservoir 6 so that the liquid solution removed from the formed part 10 by the prepressing is fed back into the reservoir 6. In addition, the molding station 20 can be connected to the preforming station 30 via suitable lines (not shown here) in such a way that the liquid solution and/or fiber material 11 that have passed through the suction head 21 via the preforming station 30, is fed back into the pulp 1 by means of the pulp preparation and replenishing unit 35 here. The movement unit 4 here comprises a robotic arm 4a that can move freely in space and on which the suction tool 2 is mounted. The robotic arm 4a is connected to the suction tool 2 using the first interface 4s. The movement unit 4 is also intended to transfer the formed parts 10 in the suction tool 2 to the prepressing unit 3 of the preforming station 30 and to the hot-pressing station 40. The movement unit 4 and the suction tool 2 are designed to leave the molded formed parts 10 in the prepressing unit 3 in the suction tool 2. The prepressing is thus performed with a prepressing lower tool 31 and the suction tool 2 as the prepressing upper tool. The prepressing pressure can be exerted on the formed parts 10 between the prepressing lower tool 31 and the suction tool 2, for example, by means of a hydraulically operated piston rod or by means of the robotic arm 4a. The prepressing can be performed at a temperature of the prepressing unit 3 of less than 80° C., preferably less than 50° C., particularly preferably at room temperature, with the prepressing pressure VD being between 0.2 N/mm² and 0.3 N/mm², preferably between 0.23 N/mm² and 0.27 N/mm². The movement unit 4 and the suction tool 2 are also designed to eject the molded formed parts 10 in the hot-pressing station from the suction tool 2 for the subsequent hot-pressing. This can be done, for example, by means of compressed air, which ejects the formed parts 10 from the suction heads 21 of the suction tool 2.

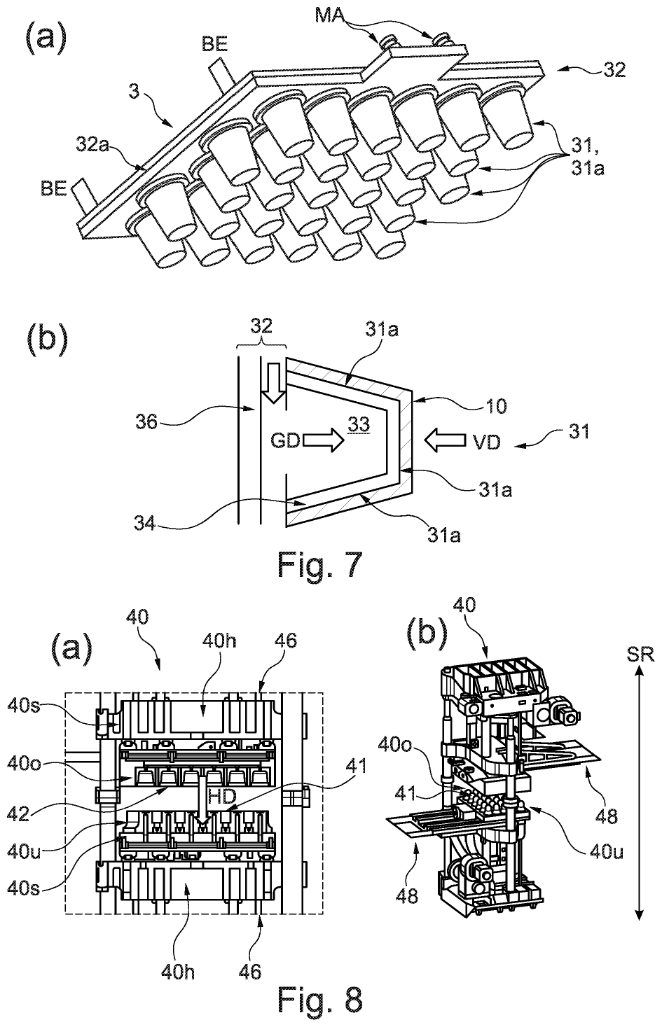

FIG. 7 shows an embodiment of the prepressing unit 3 according to the invention as a multi-tool with a plurality of prepressing lower tools 31 adapted to the suction tool 2 (a) in a perspective view of the prepressing unit 3 and (b) in a lateral section of a single prepressing lower tool 31 of the prepressing unit 3. The third interface 3s, suitable for automatically changing the prepressing unit 3, is formed by mutually compatible mechanical fastening devices BE and mutually compatible media connections MA on the prepressing unit side 3 and on the preforming station side 30 (not shown here), wherein media connections MA are heating and compressed gas connections, for example. The compatible mechanical fastening devices BE and the mutually compatible media connections MA, respectively, can be designed as a reversible quick-release system, preferably a bayonet connection and/or push-in connectors that snap into one another. On the prepressing unit side 3, the third interface 3s comprises a carrier plate 32 on which the prepressing lower tools 31 are arranged. The carrier plate 32 also comprises a transport interface 32s for automatic changing of the prepressing unit 3 by means of a movement unit 4, here the movement unit 4 of the molding station 20. The transport interface 32s is arranged as a lateral groove on the carrier plate, so that it can be removed from the preforming station 30 by the movement unit 4 during a tool change or inserted into it. The prepressing lower tool 31 is adapted here to a negative form of the suction heads 21 so that the formed part 11 can be attached to the prepressing lower tool 31 in such a way that it is arranged between the prepressing lower tool 31 and the suction tool 2 so that the suction tool 2 can pressed onto the prepressing lower tool 31 with the prepressing pressure VD. In this case, the prepressing lower tool 31 has a pressing surface 31a facing the formed part 10, which has a lower surface roughness than the screen 22 of the suction tool 2. The prepressing lower tool 31 can be made of metal, for example, or at least partially of an elastomer, preferably silicone. In the embodiments shown here, the prepressing lower tool 31 is made in part from an elastomer, in this case silicone. The prepressing lower tool 31 has a cavity 33 which is surrounded by a wall 34 made of the elastomer as a pressing surface 31a, wherein the prepressing unit 3 is designed to apply gas pressure GD to the cavity 33 during prepressing in order to create the prepressing pressure VD on the formed part 10 and the suction tool 2 or at least to support the prepressing pressure exerted by the suction tool 2 with the gas pressure GD directed in the opposite direction (see FIG. 7b). In the multi-tool, the individual prepressing lower tools 31 are arranged on a common carrier plate 32 which is provided as an interface to the prepressing unit 3 for reversible attachment to the prepressing unit and/or for supplying the individual prepressing lower tools 31 with gas pressure. Here, the carrier plate 32 also has a heating element 36 which extends over the surface of the carrier plate 32 to enable the prepressing lower tools 31 to be heated.

FIG. 8 shows an embodiment of the hot-pressing station 40 according to the invention (a) in a side view and (b) in a perspective view comprising a hot-pressing lower unit 40u as a multi-tool with a plurality of hot-pressing lower tools 41 adapted to a contour 10i of the formed part 10 for receiving the formed part 10, and a hot-pressing upper unit 400 also as a multi-tool with a plurality of hot-pressing upper tools 42 adapted to the formed part 10 for placing on or inserting into the formed part 10 along a closing direction SR for the hot-pressing station 40, wherein the hot-pressing lower tool 41 and the hot-pressing upper tool 42 exert a hot-pressing pressure HD on the formed part 10 arranged between the hot-pressing lower tool 41 and the hot-pressing upper tool 42 during hot-pressing. In the case of a negative form of a suction tool 2, the hot-pressing lower tool 41 also has a negative form (as shown here) and is thus provided as an inner tool 40i in the hot-pressing station 40, while the hot-pressing upper tool 42 is placed on it as an outer tool 40a for hot-pressing. In the case of a positive form of the suction tool 2 (not shown here), the hot-pressing lower tool 41 would also have a positive form and would be provided as an outer tool 40a, while the hot-pressing upper tool 42 would be used as an inner tool 40i for hot-pressing in the hot-pressing lower tool 41. The hot-pressing upper unit 400 and the hot-pressing lower unit 40u are reversibly mounted with the hot-pressing station 40 via respective fourth interfaces 40s for automatic changing of the hot-pressing upper unit 400 and/or the hot-pressing lower unit 40u. In addition, the hot-pressing upper unit 400 and the hot-pressing lower unit 40u are each mounted in the hot-pressing station 40 on rails 48 so that they can be moved laterally in order to enable a tool change of the respective hot-pressing lower unit 40u and hot-pressing upper unit 400 outside of a process space of the hot-pressing station 40. The space in which the hot-pressing upper unit 400 and the hot-pressing lower unit 40u move for hot-pressing is referred to as the process space. The hot-pressing pressure HD can be between 0.5 N/mm² and 1.5 N/mm², preferably between 0.8 N/mm² and 1.2 N/mm², wherein said hot-pressing pressure preferably is applied for a pressing time of less than 20s of more than 8s, more preferably between 10 and 14s, even more preferably 12s.

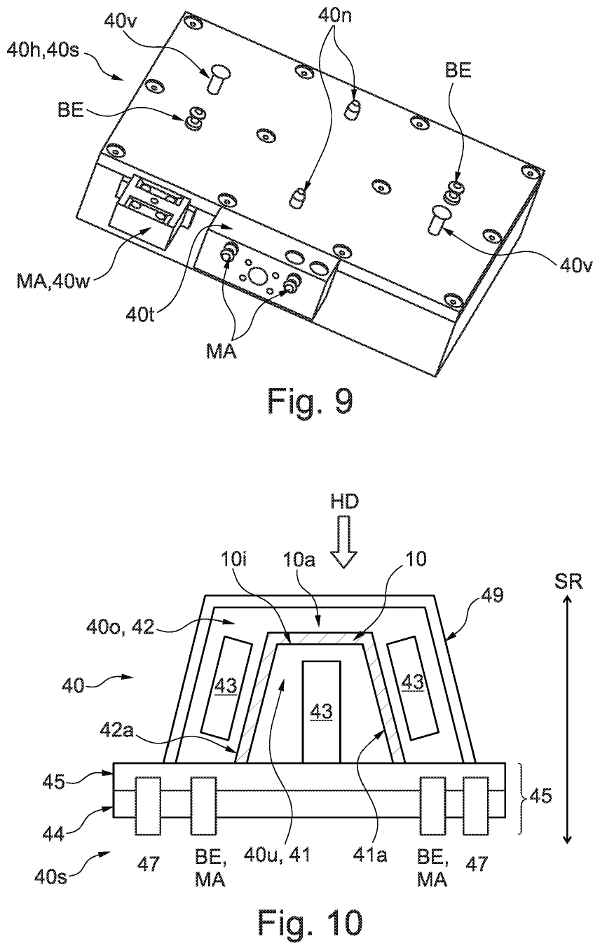

FIG. 9 shows an embodiment of a carrier plate 45 for the hot-pressing upper unit as a fourth interface 40s between the hot-pressing station 40 and the hot-pressing upper unit 40o. The fourth interface 40s is formed here by a mutually compatible mechanical fastening device BE and mutually compatible media connections MA on the hot-pressing upper unit side 40o and on a corresponding holding device side 40h of the hot-pressing station 40, designed here as a holding plate. The media connections MA comprise heating and/or compressed gas and vacuum connections. The compatible mechanical fastening device BE and the mutually compatible media connections MA are designed as a reversible quick-release system, preferably a bayonet connection and/or push-in connectors that snap into one another. The holding devices 40h have on their sides facing the respective hot-pressing upper and lower units 40o, 40u at least two defined tool zero points 40n for positioning the hot-pressing upper unit 40o and/or hot-pressing lower unit 40u on the respective holding devices 40h. In this case, the tool zero points 40n are designed to be self-centering and comprise temperature compensation. Furthermore, the holding plate 40h shown here for the hot-pressing upper unit is designed with a fall protection device 40v against detachment of the hot-pressing upper unit 400 from the holding plate 40h in the form of a pin with a wider head preventing falling, which is inserted in a slot in the carrier plate 35 during assembly and said carrier plate is moved to a designated position relative to the holding plate 40h so that the pin 40v cannot slip out. The holding device 40h also comprises a transport interface 40t perpendicular to the closing direction SR for the hot-pressing station 40, which is used for automatically changing the hot-pressing upper unit 40o and/or the hot-pressing lower unit 40u by a movement unit 4. The holding devices 40h also comprise, separately from the transport interface 40t, a heating current interface 40w for transferring a heating current to the hot-pressing upper unit 40o and/or hot-pressing lower unit 40u.

FIG. 10 shows a schematic representation of an embodiment of the hot-pressing lower tool 41 and hot-pressing upper tool 42 of the hot-pressing station 40 from FIG. 8 during hot-pressing. The respective hot-pressing sides 41a, 42a of the hot-pressing lower tool 41 and the hot-pressing upper tool 42 facing the formed part 10 are heated by means of electric heating cartridges 43. The heating cartridges 43 in the hot-pressing lower tool 41 and hot-pressing upper tool 42 are designed and arranged in such a way that the hot-pressing sides 41a, 42a can be heated to temperatures greater than 150° C., preferably between 180° C. and 250° C. The heating cartridges 43 can be controlled in such a way that the temperatures of the hot-pressing lower tool 41 and the hot-pressing upper tool 42 differ, wherein the hot-pressing upper tool 42 is able to have a higher temperature than the hot-pressing lower tool 41; the temperatures preferably differ by at least 25° C., preferably not more than 60° C., more preferably around 50° C. For this purpose, the heating cartridges 43 are arranged near the contour of the formed part 10 in the respective hot-pressing upper tools 42 and hot-pressing lower tools 41 and the respective hot-pressing upper tools 42 and hot-pressing lower tools 41 are made of metal. Here, a heating cartridge 43 is arranged centrally in the inner tool 40i parallel to the closing direction SR with a first heating output, while in the outer tool six heating cartridges 43 with second heating outputs are arranged concentrically around the closing direction SR parallel to the hot-pressing side 41a, 42a of the inner tool 40i, wherein the first heating output is greater than the second heating output. Furthermore, here the hot-pressing upper tools 42 comprise a covering 49 made of a thermally insulating material on the sides facing away from the formed part 10. The fourth interface 40s comprises a carrier plate 45 on the hot-pressing upper unit side 40o (not shown here) and the hot-pressing lower unit side 40u, on which the hot-pressing lower tools 41 are arranged here. The same would also apply to the carrier plate 45 of the hot-pressing upper unit 40o for the hot-pressing upper tools 42. The carrier plate 45 comprises a thermal insulation layer 44 in order to thermally insulate the respective carrier plates 45 against the holding device 40h. In addition, one or more expansion means 47 are arranged in the carrier plate 45 between the thermal insulation layer 44 and a side of the carrier plate 45 facing the holding device 40h in order to improve the positional accuracy of the carrier plate 45 in relation to the holding device 40h.

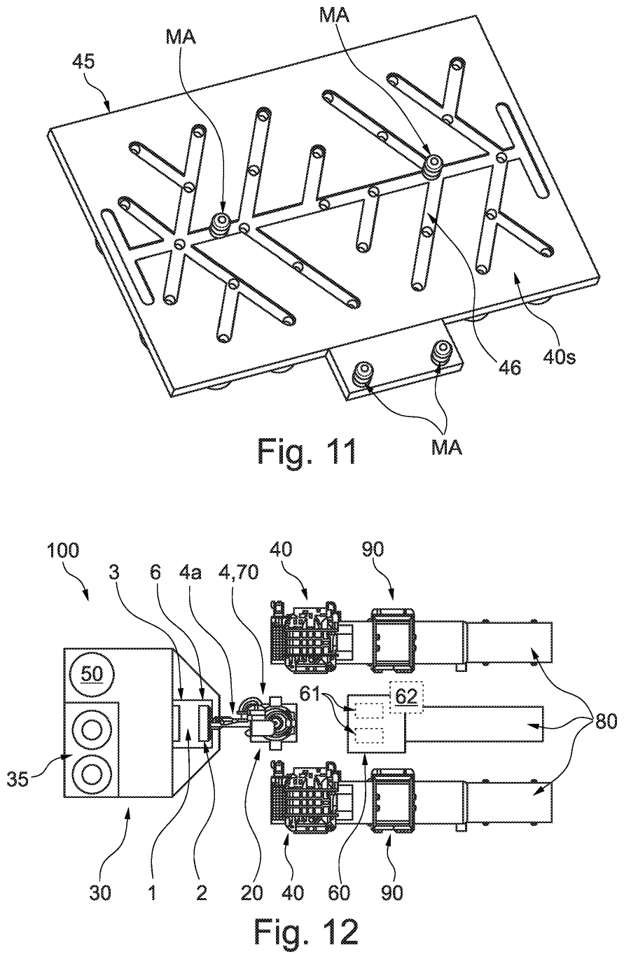

FIG. 11 shows a carrier plate 45 of the hot-pressing upper unit 40o comprising a gas line system 46 in order to create a vacuum in the respective hot-pressing upper tools 42, depending on the process step, to hold the formed parts 10 in and/or an overpressure to eject the final-shaped formed parts 10 from the hot-pressing upper tools 42. The gas line system 46 branches out laterally in the carrier plate 45 from at least one media connection MA of the fourth interface 40s to all positions of the hot-pressing upper tools 42 and is routed in the closing direction SR of the hot-pressing station 40 vertically relative to the carrier plate 45 to the hot-pressing upper tools 42. The same applies to the carrier plate 45 of the hot-pressing lower unit 40u.

FIG. 12 shows an embodiment of the fiber-forming system 100 according to the invention for producing formed parts 10 from environmentally-friendly-degradable fiber material 11, comprising a reservoir 6 for providing a pulp 1 as a liquid solution with environmentally-friendly-degradable fiber material 11 as part of the preforming station 30. In a molding station 20, a movement unit 4 immerses an attached suction tool 2 with a suction head 21 with a three-dimensionally shaped suction head suction side 21s, the shape of which is adapted to a contour of the later formed part 10, into the pulp 1. The pulp 1 is made available by a pulp processing and replenishment unit 35 and is continuously renewed and replenished during operation. The movement unit 4 is designed here as a robot with a robotic arm 4a that can move freely in space. A robot 4 can carry out precise and reproducible movements in a confined space and is therefore particularly suitable for guiding the suction tool 2 between the pulp reservoir 6 and the prepressing unit 3 of the preforming station 30. The suction tool 2 is connected to the robotic arm 4a via an interface 4s. Such an interface 4s allows the suction tool 2 to be changed quickly if necessary. The suction tool 2 is designed to mold the formed part 10 by sucking the environmentally-friendly-degradable fiber material 11 onto the suction head suction side 21s using suction pressure SD (vacuum) in the suction tool 2. The prepressing unit 3 is provided for prepressing the molded formed part 10 with a prepressing pressure VD to reduce a proportion of the liquid solution in the formed part 10 and to stabilize its shape. The hot-pressing station 40, shown here with the hot-pressing lower tool 41 visible extended to take over the preformed formed parts 10 from the suction tool 2, is provided for hot-pressing the pre-pressed formed part 10 with a hot-pressing pressure HD and thus for the final shaping of the formed part 10 and for further reducing the proportion of the liquid solution in the formed part 10. To control the fiber-forming system 100, it comprises a control unit 50, which is connected to the other components 20, 30, 35, 40, 60, 70, 80, 90 of the fiber-forming system 100 in a suitable manner in order to control these components. In particular, the fiber-forming system 100 can comprise a coating unit 90 for applying one or more functional coatings to the formed part 10. The fiber-forming system 100 is designed to enable an automatic change of tools from the molding station 20, preforming station 30 and/or hot-pressing station 40. For this purpose, the fiber-forming system 100 comprises at least one tool changing station 60, in which at least one tool 2, 3, 40o, 40u of the group of tools comprising the suction tool 2, the prepressing unit 3, the hot-pressing upper unit 40o and/or the hot-pressing lower unit 40u can be positioned for an automatic tool change for a respective other tool 2, 3, 40o, 40u in the fiber-forming system 100. For this purpose, the tool changing station 60 comprises a plurality of tool changing positions 61 which are adapted to the shape of the respective tool 2, 3, 40o, 40u. The tool changing station 60 also comprises a conveyor belt 80 for the tools 2, 3, 40o, 40u to be changed, which is designed to transport the tools 2, 3, 40o, 40u to be changed to the respective tool changing positions 61 or the changed tool 2,3,40o, 40u to be transported out of the tool change positions 61 again. For this purpose, the tool changing station 60 comprises a movement unit 62, preferably a robot with a gripper arm, to place the tools 2, 3, 40o, 40u provided with the conveyor belt 80 in the desired tool changing positions 61. The movement unit 62 preferably recognizes the tools and the tool positions 61 provided for them, for example, by means of an identification code on the respective tool. The tool positions 61 assigned to the tool can also be encoded or are stored in a table in the controller of the movement unit 62 for execution. As an alternative to the conveyor belt 80, the tool changing station 60 may comprise a movement unit 62 designed as a robot for the tools 2, 3, 40o, 40u to be changed, which is designed to transport the tools 2, 3, 40o, 40u to the respective tool changing positions 61 or to transport the changed tool 2, 3, 40o, 40u out of the tool change positions 61 again. As shown here, the movement unit 4 of the molding station 20, the preforming station 30, the hot-pressing station 40 and the tool changing station 60 are preferably positioned relative to one another such that the movement unit 4 of the molding station 20 in an additional function as a changing unit 70 can change the tools 2, 3, 40o, 40u of these stations 20, 30, 40 are automatically deposited and removed in the tool changing station 60, with at least the respective transport interfaces 32s, 40t of the preforming station 20 and/or the hot-pressing station 40 being configured in such a way that they are friendly with the first interface 4s of the movement unit 4 as changing unit 70.

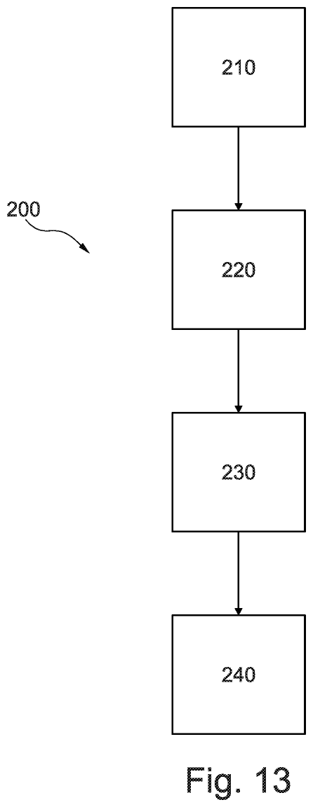

FIG. 13 shows a schematic representation of an embodiment of the method 200 according to the invention for automatically changing tools in a fiber-forming system 100 according to the invention, comprising the steps of providing 210 a tool 2, 3, 40o, 40u to be changed in a changing station 60 in a first changing position 61; depositing 220 the exchanged tool 2, 3, 40o, 40u in the changing station 60 in a second changing position 61; removing 230 the tool 2, 3, 40o, 40u to be exchanged from the first changing position 61 and inserting this tool 2, 3, 40o, 40u depending on the tool 2, 3, 40o, 40u in a molding station 20 according to the invention, a preforming station 30 according to the invention and a hot-pressing station 40 according to the invention; and the removal of the exchanged tool 2, 3, 40o, 40u from the second changing position 61 from the changing station 60.

At this point it should be explicitly pointed out that features of the solutions described above or in the claims and/or figures can also be combined if appropriate in order to be able to implement or achieve the features, effects and advantages explained in a cumulative manner.

It goes without saying that the exemplary embodiment explained above is merely a first embodiment of the present invention. In this respect, the design of the invention is not limited to this exemplary embodiment.

### LIST OF REFERENCE SIGNS

1 pulp
11 environmentally-friendly, degradable fiber material
2 suction tool
21 suction head
21a suction head outside
21i suction head inside
21p end face of the suction head facing the pulp
21s suction head suction side
22 porous screen of the suction head
22p pulp-facing side (pulp side) of the screen
22s side of the screen facing the suction side surface 23s
23 suction channels in the suction head
23s suction-side surface of the suction head
24 push-in connectors for attaching the suction heads/modules to the base plate
25 discharge channel for the liquid solution
26 base plate of the suction tool
26s second interface
27 gas line system in the base plate
28 reversible attachment means for the screen, e.g. clamping means
29 modules with suction heads
3 prepressing unit
3s third interface
31 prepressing lower tool
31a pressing surface of the prepressing lower tool
32 carrier plate
32s transport interface of the carrier plate 32
33 cavity in prepressing lower tool
34 wall as the pressing surface of the prepressing lower tool
36 carrier plate heating element 32
4 movement unit
4a robotic arm that can move freely in the space
4s first interface
41 hot-pressing lower tool of the hot-pressing station
41a hot-pressing side of the hot-pressing lower tool, e.g. the outside
42 hot-pressing upper tool of the hot-pressing station
42a hot-pressing side of the hot-pressing upper tool, e.g. the inside
43 heating cartridges
44 thermal insulation layer
45 carrier plates for the respective hot-pressing lower tool and hot-pressing upper tool designed as a multi-tool
46 gas line system in the carrier plate 45
47 expanding means
48 rails for lateral movement of the hot-pressing upper and lower units
49 cover made of a thermally insulating material
6 reservoir of pulp
10 formed part made from environmentally-friendly-degradable fiber material
10a inner contour (inside) of the formed part
10i outer contour (outside) of the formed part
20 molding station
30 preforming station
35 pulp preparation and replenishment unit
40 hot-pressing station
40u hot-pressing lower unit
40o hot-pressing upper unit
40h holding device of the hot-pressing station for the hot-pressing lower unit or the hot-pressing upper unit
40s fourth interface between the hot-pressing lower unit or hot-pressing upper unit and the hot-pressing station
40t transport interface
40n tool zero point
40v fall protection for the hot-pressing upper unit 40w heating current interface
50 control unit
60 tool changing station
61 tool changing position
62 movement unit of the changing station
70 changing unit
80 conveyor belt
90 other components of the fiber-forming system, e.g. coating station
100 fiber-forming system
200 process for the automatic changing of tools in a fiber-forming system
210 providing a tool to be exchanged in a changing station
220 depositing the exchanged tool in the changing station
230 removing the tool to be exchanged from the changing station and insertion of thi into one of the stations of the fiber-forming system, depending on the tool
240 removing the exchanged tool from the changing station
A-B cutting line in FIG. 4
BE fastening device
GD gas pressure
HD hot-pressing pressure
MA mutually compatible media connections
SD suction pressure (pulp against suction head)
SR closing direction (pressing direction) of the hot-pressing station
VD prepressing pressure

1-42. (canceled)

43. A system for forming molded parts, comprising:
at least one molding station comprising:
a suction tool configured to suck in a pulp from a reservoir, wherein the pulp is a liquid solution comprising an environmentally-friendly degradable fiber material positioned in the reservoir, and wherein the suction tool is configured to form a molded part during application of a negative pressure in the suction tool; and
a movement unit on which the suction tool is reversibly mounted, wherein the movement unit is configured to move the suction tool to be in contact with the pulp;
a preforming station comprising a prepressing tool, the prepressing tool being configured to preform the molded part by applying a prepressing pressure to reduce a proportion of the liquid solution in the molded part, wherein the prepressing tool is reversibly mounted in the preforming station;
a hot-pressing station comprising a hot-pressing tool, the hot-pressing tool being configured to exert a hot-pressing pressure on the molded part, wherein the hot-pressing tool is reversibly mounted in the hot-pressing station; and
an automatic tool change device, wherein the automatic tool change device is configured to remove at least one tool selected from the suction tool, the prepressing tool, and the hot-pressing tool and replace the removed tool with a replacement tool.

44. The system of claim 43, further comprising at least one tool changing station in which at least one tool selected from the suction tool, the prepressing tool, and the hot-pressing tool is positioned for an automatic tool change by the automatic tool change device.

45. The system of claim 44, wherein the at least one tool changing station comprises three tool changing positions, a first tool changing position adapted to a shape of the suction tool, a second tool changing position adapted to a shape of the prepressing tool, and a third tool changing position adapted to a shape of the hot-pressing tool.

46. The system of claim 45, wherein the automatic tool change device comprises a conveyor belt for the suction tool, the prepressing tool, and the hot-pressing tool, wherein the conveyor belt is configured to transport a tool being removed out of its corresponding tool changing position, and wherein the conveyor belt is configured to transport a replacement tool to said tool changing position.

47. The system of claim 46, wherein the at least one tool changing station includes a tool changing movement unit configured to place the tool provided by the conveyor belt in the corresponding tool changing position.

48. The system of claim 43, wherein the suction tool is reversibly mounted to the movement unit via a first interface, wherein the prepressing tool is reversibly mounted to the movement unit via a second interface, and wherein the hot-pressing tool is reversibly mounted to the movement unit via a third interface.

49. The system of claim 48, wherein the movement unit is configured to automatically move at least one of the suction tool, the prepressing tool, and the hot-pressing tool into or out of the at least one tool changing station, and wherein the second interface and the third interface are transport interfaces are configured to be compatible with the first interface.

50. The system of claim 48, wherein the first interface includes mutually compatible media connections for vacuum and overpressure, and mutually compatible mechanical fastening devices on a movement unit side and a suction tool side of the first interface.

51. The system of claim 48, wherein the second interface includes mutually compatible mechanical fastening devices on a prepressing tool side and on a preforming station side of the second interface.

52. The system of claim 48, wherein the third interface includes mutually compatible mechanical fastening devices and mutually compatible media connections on a hot-pressing tool side and on a corresponding holding device side of the hot-pressing station.

53. The system of claim 43, further comprising a control unit configured to control at least the molding station, the preforming station, the hot-pressing station, and the automatic tool change device.

54. A method for changing tools in a fiber-forming apparatus, comprising:
placing a replacement tool in a first changing position of a tool changing station corresponding to the replacement tool, the replacement tool being one of a suction tool, a prepressing tool, and a hot-pressing tool;
removing a tool to be exchanged from a station in a fiber-forming apparatus, the station being one of a molding station, a preforming station, and a hot-pressing station, wherein the exchanged tool and the replacement tool correspond to the station from which the exchanged tool is removed;
placing the exchanged tool in a second changing position of the changing station corresponding to the exchanged tool;
moving the replacement tool from the first changing position to the station from which the exchanged tool has been removed; and
removing the exchanged tool from the second changing position and the changing station.

55. The method of claim 54, wherein the changing station comprises:
first and second changing positions corresponding to the suction tool, the suction tool corresponding changing positions being adapted to a shape of the suction tool;
first and second changing positions corresponding to the prepressing tool, the prepressing tool corresponding changing positions being adapted to a shape of the prepressing tool; and
first and second changing positions corresponding to the hot-pressing tool, the hot-pressing tool corresponding changing positions being adapted to a shape of the hot-pressing tool.

56. The method of claim 54, further comprising removing the exchanged tool from the second changing position on a conveyor belt attached to the second changing position.

57. The method of claim 54, further comprising removing the tool to be exchanged from the station in the fiber-forming apparatus with a robotic arm.

58. The method of claim 54, further comprising moving the replacement tool from the first changing position to a location of the station from which the exchanged tool has been removed on a conveyor belt.

59. The method of claim 58, further comprising moving the replacement tool from the conveyor belt to the station from which the exchanged tool has been removed with a robotic arm.

60. A tool change device for a fiber-forming apparatus, comprising:
a conveyor belt for moving a plurality of tools to and from a plurality of tool changing positions, a first tool changing position corresponding to a suction tool, a second tool changing position corresponding to a prepressing tool, and a third tool changing position corresponding to a hot-pressing station; and
a movement unit configured to move a tool between its corresponding tool changing position and a station corresponding to the tool located on the fiber-forming apparatus, the station being one of a molding station corresponding to the suction tool, a preforming station corresponding to the prepressing tool, and a hot-pressing station corresponding to the hot-pressing tool.

61. The device of claim 60, wherein the movement unit is a robotic arm configured to be operate freely between the tool changing positions and the stations.

62. The device of claim 60, wherein the first tool changing position is adapted to a shape of the suction tool, the second tool changing position is adapted to a shape of the prepressing tool, and the third tool changing position is adapted to a shape of the hot-pressing tool.
